(19) United States
(12) Patent Application Publication
(10) Pub. No.: US 2025/0030206 A1
(43) Pub. Date: Jan. 23, 2025

(54) CONNECTOR CORROSION MITIGATION

(71) Applicant: TEXAS INSTRUMENTS INCORPORATED, Dallas, TX (US)

(72) Inventor: Deric Wayne WATERS, Dallas, TX (US)

(21) Appl. No.: 18/353,593

(22) Filed: Jul. 17, 2023

(51) Int. Cl. H01R 13/66; G06F 13/40

(52) U.S. Cl. CPC H01R 13/6683; G06F 13/4068; H01R 13/6691; G06F 2213/0042

(57) ABSTRACT

In some examples, an integrated circuit (IC) is configured to detect, by the IC, a presence of liquid in an electrical connector. The IC is also configured to, responsive to the presence of liquid in the electrical connector, remove a bias voltage from at least some conductors of the electrical connector. The IC is also configured to monitor a bus voltage of the electrical connector. The IC is also configured to, based on a value of the bus voltage determined via the monitoring, perform a mitigation action responsive to the presence of liquid in the electrical connector.

### BACKGROUND

Electrical connectors include metallic conductors on which a voltage may be present or through which a current may flow. Connectors may include both plugs and receptacles, where the plug is inserted into the receptacle to form an electrical connection between the plug and the receptacle. Because connectors include openings to facilitate their connection, the connectors are susceptible to liquid entering the openings. Liquid in a connector may cause damage to an electrical device coupled by the connector as well as the connector itself, to the conductors of the connector, or the like.

### SUMMARY

In some examples, an integrated circuit (IC) is configured to detect, by the IC, a presence of liquid in an electrical connector. The IC is also configured to, responsive to the presence of liquid in the electrical connector, remove a bias voltage from at least some conductors of the electrical connector. The IC is also configured to monitor a bus voltage of the electrical connector. The IC is also configured to, based on a value of the bus voltage determined via the monitoring, perform a mitigation action responsive to the presence of liquid in the electrical connector.

In some examples, a method includes introducing an electrical current into an electrical connector. The method also includes measuring a voltage in the electrical connector provided responsive to the electrical current. The method also includes determining, based on a value of the voltage, a presence of a foreign material in the electrical connector. The method also includes responsive to the presence of the foreign material in the electrical connector, removing a bias voltage from at least some conductors of the electrical connector.

In some examples, an apparatus includes a Universal Serial Bus (USB) receptacle and a USB controller. The USB controller is coupled to the USB receptacle. The USB controller configured to detect a presence of liquid in the USB receptacle. The USB controller is also configured to, responsive to the presence of liquid in the USB receptacle, remove a bias voltage from at least some conductors of the USB receptacle.

### BRIEF DESCRIPTION OF THE DRAWINGS

FIG. 1 is a block diagram of a system, in accordance with various examples.

FIG. 2 is a schematic diagram of a system, in accordance with various examples.

FIG. 3 is a schematic diagram of a system, in accordance with various examples.

FIG. 4 is a flowchart of a method, in accordance with various examples.

### DETAILED DESCRIPTION

As described above, electrical connectors include metallic conductors on which a voltage may be present or through which a current may flow. Connectors may include both plugs and receptacles, where the plug is inserted into the receptacle to form an electrical connection between the plug and the receptacle. Examples of connectors include, among others, USB connectors, Ethernet connectors, power (e.g., alternating current (AC) or direct current (DC)) connectors, etc. Because connectors include openings to facilitate their connection to one another, the connectors are susceptible to liquid entering the openings. Liquid in a connector may cause damage to an electrical device including the connector, to the conductors of the connector, or the like. For example, in a scenario in which a liquid or other conductive material is present in the opening of a connector and creating a resistive path between two conductors, or pins, of the connector, corrosion of one or both of the conductors may occur in the presence of a voltage potential difference between the conductors. In some examples, corrosion may occur in the presence of a voltage potential difference of 0.5 volts (V) or greater. The corrosion may be, for example, a result of electrolysis, resulting in a chemical breakdown of the conductors that may be challenging to repair and may adversely affect operation of a device including a connector that includes the conductor(s).

Examples of this description provide for connector corrosion mitigation. For example, a connector may be monitored to determine whether a liquid or other conductive material is present and creating a resistive path between two or more conductors of the connector. Responsive to a determination that liquid or another conductive material is present and creating a resistive path between two or more conductors of the connector, a bias voltage is removed from at least some of the conductors. As used herein, a bias voltage may be a non-zero voltage of any suitable value, or may be a ground voltage potential. In some examples, removing the bias voltage from the conductor(s) reduces a voltage potential difference between or among the conductors, mitigating the conditions under which corrosion of the conductor(s) may occur. For example, responsive to removing the bias voltage from the conductor(s), the conductor(s) may be pulled up through the liquid or other conductive material to approximately a highest remaining voltage provided on a conductor of the connector. In this way, corrosion of the conductor(s) is prevented or reduced in comparison to scenarios in which the bias voltage is not removed from the conductor(s) in the presence of the liquid or other conductive material.

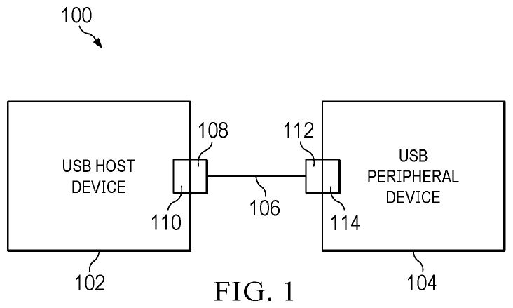

FIG. 1 is a block diagram of a system 100, in accordance with various examples. The system 100 includes a USB host device 102 (which may be referred to as, or include, a USB controller, and may be implemented at least in part as an IC) and a USB peripheral device 104, coupled via a USB cable 106. For example, the USB cable 106 has a first plug 108 that couples (e.g., inserts) into a receptacle 110 of the USB host device 102, and a second plug 112 that couples (e.g., inserts) into a receptacle 114 of the USB peripheral device 104. In some examples, the first plug 108 and the receptacle 110 are omitted and the USB cable 106 is coupled to the USB host device 102 in a non-plugged manner (e.g., soldered). In other examples, the second plug 112 and the receptacle 114 are omitted and the USB cable 106 is coupled to the USB peripheral device 104 in a non-plugged manner (e.g., soldered). While this description generally discusses examples in the context of USB, other cable, plug, receptacle, and device types are possible. For example, the examples of this description are generally applicable to any connectors having conductors between which a voltage differential may exist and which are susceptible to having a liquid or other conductive material enter the connector. In some examples, the USB cable 106 is a USB type-C (USB-C) cable.

In some examples, the first plug 108 and/or the receptacle 110 include a first conductor (not shown) on which a first voltage is provided. The first voltage may be a bus voltage (VBUS), such as defined according to a specification or standard to which the USB cable 106, the first plug 108 and/or the receptacle 110 are manufactured. In an example, such as USB-C, VBUS is approximately 5 V. The first plug 108 and/or the receptacle 110 also includes a second conductor (not shown) which is biased according to a second voltage. The second voltage may be defined according to a specification or standard to which the USB cable 106, the first plug 108 and/or the receptacle 110 are manufactured. In an example, such as USB-C, the second voltage may be approximately 3.3 V. In various examples, the first plug 108 and/or the receptacle 110 may include any number of additional conductors (not shown) which may be biased at the second voltage or at any other suitable voltages, the scope of which is not limited herein. The teachings of this description in reference to the second conductor may also apply to these additional conductors. Similarly, while the first plug 108 and receptacle 110 are described for the sake of simplicity, such description may be applicable to examples of the second plug 112 and the receptacle 114.

In an example, in the presence of a conductive liquid or other foreign material, a voltage potential difference between the first conductor and the second conductor may be sufficient to cause corrosion or other damage to the first conductor and/or the second conductor. For example, electrolytic corrosion, a form of electrolysis, is a chemical reaction in which an electrical charge flows (such as resulting from the voltage potential difference) through a transmission medium (e.g., the conductive liquid or other foreign material) between two or more conductors. The electrical charge interacts with an electrolyte in the transmission medium to transfer electrons from an anode metal (e.g., the conductor at the lower voltage potential, such as the second conductor) and deposit the electrons at the cathode metal (e.g., the conductor at the higher voltage potential, such as the first conductor). In other examples, galvanic corrosion may occur in the presence of the conductive liquid or other foreign material if the first and second conductors have different chemical structures (e.g., one conductor metal type is different from the other, one conductor has more impurities than the other, etc.). The corrosion may adversely affect operation of the USB host device 102, the receptacle 110, the first plug 108, and/or the USB cable 106, such as by reducing performance or preventing normal operation of the device.

To mitigate the potential for, or occurrence of, corrosion, the USB host device 102 monitors the receptacle 110 for the presence of a conductive liquid or other foreign material. The monitoring may be performed according to any suitable process, the scope of which is not limited herein. The monitoring may be performed via use of conductors of the receptacle 110, or by components, sensors, and/or circuitry of the USB host device 102 other than conductors of the receptacle 110 but at least some of which have access to the receptacle 110. In an example, determination of the presence of a conductive liquid or other foreign material may be made according to electrical impedance spectroscopy. In other examples, determination of the presence of a conductive liquid or other foreign material may be made via leakage or resistance measurement in which a voltage or current is applied through a known resistor to a terminal and a voltage at the terminal is measured. In other examples, the determination of the presence of a conductive liquid or other foreign material may be performed according to any suitable electrical impedance spectroscopy, such as described in Roadmap for Electrical Impedance Spectroscopy for Sensing: A Tutorial, L. A. Buscaglia, O. N. Oliveira, Jr, and J. P. Carmo, IEEE SENSORS JOURNAL, vol. 21, no. 20, Oct. 15, 2021; A Pulsed Approach for Electrical Impedance Spectroscopy Measurement, D. Ensheng, J. Yilin, G. Wei, Z. Jianfei, 2010 International conference on intelligent system design and engineering application; or A CMOS Magnitude/Phase Measurement Chip for Impedance Spectroscopy, P. Kassanos, I. F. Triantis, A. Demosthenous, IEEE SENSORS JOURNAL, vol. 13, no. 6, June 2013, each of which is incorporated herein by reference in its entirety. In various other examples, any suitable process for determining the presence of a conductive liquid or other foreign material may be used, the scope of which is not limited herein.

Responsive to detecting the presence of the conductive liquid or other foreign material, the USB host device 102 takes mitigation action(s). In some examples, mitigation actions include the USB host device 102 generating and/or providing of an alert or other notification to a user. In other examples, mitigation actions include modifying operation of the receptacle 110. For example, the USB host device 102 may modify biasing of the second conductor responsive to detecting the presence of the conductive liquid or other foreign material. In some examples, the modifying may be to remove the biasing to place the second conductor in a high impedance (high-z) state. In other examples, the modifying may be applying voltage approximately equal to VBUS as the biasing. In other examples, the modifying may be applying a pull-down resistance (e.g., such as less than or equal to 1.1 kiloohms) between the second conductor and a ground voltage potential. By decreasing a voltage potential difference between the first and second conductors, a reduced amount of charge (e.g., current) flows between the first and second conductors through the conductive liquid or other foreign material. Reducing the charge flowing between the first and second conductors reduces the potential for electrolysis, mitigating the possibility of corrosion of the first and/or second conductors. While described above as the first and second conductors both being of the receptacle 110, in various examples the first and/or second conductors may instead be of the first plug 108, such as in an operational circumstance in which the first plug 108 is connected to the receptacle 110.

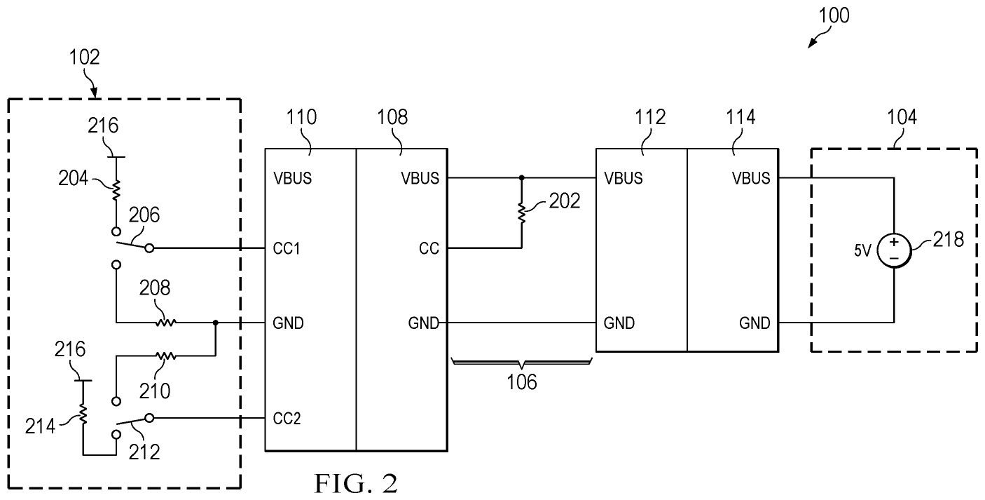

FIG. 2 is a schematic diagram of the system 100, in accordance with various examples. As described above, the first plug 108 includes any suitable number of conductors. As shown in FIG. 2, these conductors include at least a VBUS conductor, a configuration channel (CC) conductor, and a ground voltage potential (GND) conductor. Further, the receptacle 110 includes at least a VBUS conductor, a CC1 conductor, a GND conductor, and a CC2 conductor. The second plug 112 and receptacle 114 each include at least VBUS and GND conductors. However, in various examples, the first plug 108, receptacle 110, second plug 112, and/or receptacle 114 may include any additional, or alternative, conductors suitable for a communication protocol, standard, or other specification according to which the first plug 108, receptacle 110, second plug 112, and/or receptacle 114 operate.

In an example, the first plug 108 (or in other examples, the USB cable 106) includes a resistor 202 coupled between the VBUS and CC conductors of the first plug 108. In an example, the USB host device 102 includes a resistor 204, a switch 206, a resistor 208, a resistor 210, a switch 212, a resistor 214, and a power supply 216. In some examples, the switch 206 and the switch 212 are multi-pole switches that are selectable or controllable between at least three distinct states. In an example, the USB peripheral device 104 includes a power supply 218.

The resistor 204 has a first terminal coupled to the power supply 216 and a second terminal. The switch 206 has a first terminal coupled to the CC1 conductor of the receptacle 110, a second terminal coupled to the second terminal of the resistor 204, and has a third terminal. The resistor 208 has a first terminal coupled to the ground conductor of the receptacle 110 and a second terminal coupled to the third terminal of the switch 206. The resistor 210 has a first terminal coupled to the ground conductor of the receptacle 110, and has a second terminal. The switch 212 has a first terminal coupled to the CC2 conductor of the receptacle 110, a second terminal coupled to the second terminal of the resistor 210, and has a third terminal. The resistor 214 has a first terminal coupled to the third terminal of the switch 212 and a second terminal coupled to the power supply 216. The power supply 218 has a positive terminal coupled to the VBUS conductor of the receptacle 114 and a negative terminal coupled to the ground conductor of the receptacle 114. Although not shown in FIG. 2, in various examples the switch 206 and the switch 212 each have control terminals. A controller (not shown) may be coupled to the control terminals to control a state of the switches 206, 212.

In an example of operation of a source-only system, the switch 206 couples to the resistor 204 during normal operation. Similarly, the switch 212 couples to the resistor 214 during normal operation. In an example of operation of a dual-role power (DRP) system, the switch 206 couples to the resistor 204 while in the source mode and to the resistor 208 while in the sink mode. While unconnected, the system would periodically change between the source and the sink modes. The switch 212 would operate in the same manner as the switch 206. In some examples, the resistors 204, 214 may be replaced by a current source to achieve similar function.

Responsive to determination by the USB host device 102 of the presence of a conductive liquid or other foreign material in the receptacle 110, the USB host device 102 may perform mitigation actions. For example, the USB host device 102 may control the switch 206 and/or the switch 212 to open such that the CC1 conductor is coupled to neither the resistor 204 nor the resistor 208, and the CC2 conductor is coupled to neither the resistor 210 nor the resistor 214. Thus, the CC1 conductor and/or the CC2 conductor, respectively, may be in a high-z state. While in the high-z state, the conductive liquid or other foreign material may function as a resistor that pulls the CC1 and/or CC2 conductor high to have a value approximately equal to a voltage provided on VBUS. In this way, a voltage potential differential between the VBUS conductor of the receptacle 110 and the CC1 and/or CC2 conductors of the receptacle 110 and first plug 108 is decreased. In another example, the USB host device 102 may control the switch 206 and/or the switch 212 to close such that the CC1 conductor and the CC2 conductor are coupled to a third power supply (not shown) that provides a voltage greater than a voltage provided by the power supply 216 and less than or equal to VBUS, thus decreasing the voltage potential differential between the VBUS conductor of the receptacle 110 and the CC1 and/or CC2 conductors of the receptacle 110 and first plug 108. The decreased voltage potential differential reduces the potential for electrolysis, mitigating the possibility of corrosion of the VBUS conductor, CC1 conductor, and/or CC2 conductor.

In some examples, the USB host device 102 may perform further mitigation action(s). For example, after modifying the switches 206, 212 to place the CC1 conductor and the CC2 conductor in the high-z state, the USB host device 102 may monitor a value of VBUS. Responsive to VBUS decreasing in value to approximately equal the ground voltage potential, the USB host device 102 may control the switch 206 and/or the switch 212 to close such that the CC1 conductor and the CC2 conductor are coupled through the resistors 208, 210 to the GND conductor, thus maintaining the decreased voltage potential differential between the VBUS conductor, CC1 conductor, and/or CC2 conductor. Responsive to VBUS not decreasing in value within a programmed amount of time, the USB host device 102 may generate and/or provide an alert or other notification to a user. In some examples, the alert may prompt the user to remove the first plug 108 from the receptacle 110. In some examples, the USB host device 102 continues to monitor to determine whether the conductive liquid or other foreign material remains in the receptacle 110. In some examples, responsive to determining that the conductive liquid or other foreign material is no longer present in the receptacle 110, the USB host device 102 returns to normal operation according to a communication protocol, standard, or other specification according to which the USB host device 102 operates in the absence of the conductive liquid or other foreign material. For example, responsive to determining that the conductive liquid or other foreign material is no longer present in the receptacle 110, the USB host device 102 terminates mitigating actions that have been taken, such as the placing of one or more conductors of the receptacle 110 in the high-z state or modifying a bias voltage applied to one or more conductors of the receptacle 110.

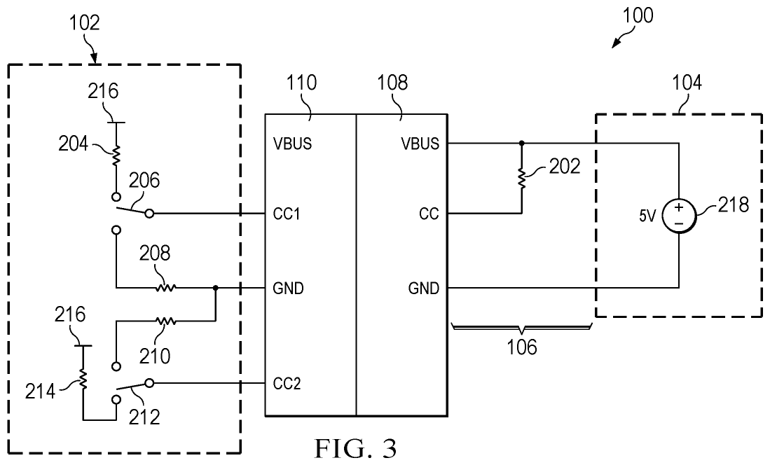

FIG. 3 is a schematic diagram of the system 100, in accordance with various examples. The system 100 as shown in FIG. 3 is representative of an application environment in which the second plug 112 and the receptacle 114 are omitted and the USB cable 106 is coupled to the USB peripheral device 104 in a non-plugged manner (e.g., soldered). A remainder of operation of the system 100 as shown in FIG. 3 may be substantially similar to that described above with respect to the system 100 of FIG. 2, and such description is not repeated herein with respect to FIG. 3.

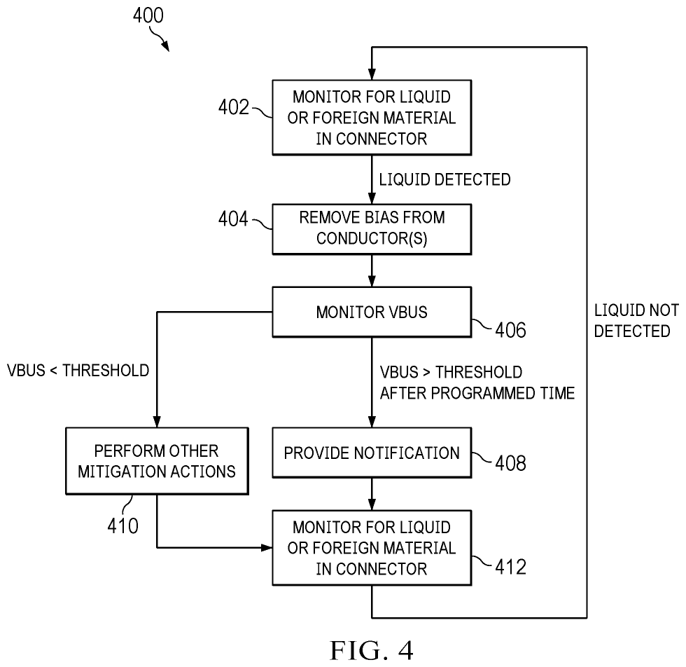

FIG. 4 is a flowchart of a method 400, in accordance with various examples. In some examples, the method 400 is implemented by a device such as the USB host device 102, for example to perform corrosion mitigation of a receptacle or plug coupled to the receptacle, such as the receptacle 110 and/or the first plug 108.

At operation 402, the device monitors for a conductive liquid or other foreign material in the connector, such as a receptacle for receiving a plug. In some examples, the device monitors for the conductive liquid or other foreign material through a process of electrical impedance spectroscopy, or any other suitable process that enables the device to electrically identify the presence of the conductive liquid or other foreign material within the receptacle. In some examples, monitoring for the conductive liquid or foreign material in the receptacle includes introducing an electrical current into the receptacle, measuring a voltage in the receptacle provided responsive to the current, and determining, based on a value of the voltage, that the liquid of other foreign material is present in the electrical connector. In some examples, operation 402 may be considered a normal, or default mode of operation of the device. For example, while operating according to operation 402, the device may monitor for a conductive liquid or other foreign material in the connector while otherwise operating according to a communication protocol, standard, or other specification according to which the device 402 is programmed to operate (e.g., USB, USB-C, etc.).

At operation 404, responsive to detection of the presence of the conductive liquid or other foreign material in the receptacle, the device modifies a biasing of at least some conductors of the receptacle. In some examples, the conductors include any combination of a CC conductor, one or more data conductors, or other conductors which are biased with a first voltage at least a threshold amount less than a VBUS conductor of the receptacle. In some examples, the data conductors are differential data conductors (e.g., D+/D−), sideband use (SBU) conductors, CC conductors, or the like. In an example, the modifying includes biasing the conductors at a voltage of VBUS, biasing the conductors with a second voltage that is greater than the first voltage but less than VBUS, or removing the biasing such that the conductor(s) are in a high-z state. In some examples, removing the biasing includes decoupling the conductor(s) from a current source or pull-up resistance that couples the conductor(s) to a power source. In other examples, removing the biasing includes decoupling the conductor(s) from a pull-down resistance that couples the conductor(s) to another voltage source, or a ground voltage potential (e.g., a ground terminal). In some examples, the conductive liquid or other foreign material pulls the conductor(s) in the high-z state up to have a voltage of approximately VBUS.

At operation 406, the device monitors a value of VBUS to determine whether VBUS has decreased in value to be less than a threshold, such as about 0.8 V. In some examples, the threshold indicates that power has been removed from the VBUS conductor, such as via removal of the plug from the receptacle, ceasing to transmit power through the plug or receptacle, or the like.

At operation 408, responsive to VBUS not decreasing in value to be less than the threshold in a programmed amount of time, the device may provide a notification to a user. In some examples, the programmed amount of time is about 650 milliseconds (ms). In various other examples, the programmed amount of time may be greater than about 650 ms. However, in some examples, as the programed amount of time increases, the greater amount of corrosion that may take place and may be avoidable at programmed amounts of time closer in value to 650 ms. The notification may be informative or to prompt action. For example, the notification may alert the user that the conductive liquid or other foreign material has been detected in the receptacle, that the conductive liquid or other foreign material has been detected in the receptacle and VBUS is provided in the receptacle, that a risk of corrosion or damage to the receptacle exists, or any other suitable alert to notify the user about the presence of the conductive liquid or other foreign material in the receptacle and/or the risk of damage to the receptacle. In other examples, the notification may prompt the user to act, such as prompting the user to remove the plug from the receptacle, to disable VBUS, or any other suitable action to mitigate the possibility of corrosion to the receptacle and/or plug.

At operation 410, the device performs other mitigation action(s). For example, responsive to VBUS decreasing in value to be less than the threshold, the device may pull down at least some conductors (e.g., the conductors for which biasing was modified at operation 404) to approximately a ground voltage potential, approximately a value of VBUS, or to another voltage less than the threshold. For example, the conductor(s) may be pulled down by coupling the conductors to a reference (e.g., a ground terminal, a reference terminal, etc.) through a resistor or other circuit having a low resistance (e.g., less than or equal to about 1.1 kiloohm).

At operation 412, the device monitors the receptacle to determine whether the conductive liquid or other foreign material is still present in the receptacle. The monitoring of operation 412 may be substantially the same as the monitoring of operation 402. The device may check the receptacle for the presence of the conductive liquid or other foreign material periodically. In some examples, the periodicity may be about every 1 second, while in other examples, any other suitable value for the periodicity may be used. Responsive to determining that the conductive liquid or other foreign material is no longer present in the receptacle, the method 400 returns to operation 402. Otherwise, the method 400 remains at operation 412. In some examples, responsive to returning from operation 412 to operation 402, the device returns to normal operation according to a communication protocol, standard, or other specification according to which the device operates in the absence of liquid. For example, responsive to returning from operation 412 to operation 402, the device terminates mitigating actions taken at operation 404 and/or 410.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or IC package) and may be coupled to at least some of the passive elements and/or the sources to form the described structure either at a time of manufacture or after a time of manufacture, for example, by an end-user and/or a third-party.

While certain components may be described herein as being of a particular process technology, these components may be exchanged for components of other process technologies. Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground voltage potential” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter. Modifications are possible in the described examples, and other examples are possible within the scope of the claims.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an IC, a device, or a semiconductor component. Furthermore, a voltage rail or more simply a “rail,” may also be referred to as a voltage terminal and may generally mean a common node or set of coupled nodes in a circuit at the same potential.

What is claimed is:

1. An integrated circuit (IC) configured to:
detect, by the IC, a presence of liquid in an electrical connector;
responsive to the presence of liquid in the electrical connector, remove a bias voltage from at least some conductors of the electrical connector;
monitor a bus voltage of the electrical connector; and
based on a value of the bus voltage determined via the monitoring, perform a mitigation action responsive to the presence of liquid in the electrical connector.

2. The IC of claim 1, wherein responsive to the bus voltage not decreasing to be less than a threshold value, the mitigation action includes providing a notification to a user.

3. The IC of claim 1, wherein responsive to the bus voltage decreasing to be less than a threshold value, the mitigation action includes applying a pull-down resistance to the at least some conductors.

4. The IC of claim 1, wherein the IC is configured to, responsive to the presence of liquid in the electrical connector, apply a second bias voltage to the at least some conductors of the electrical connector, the second bias voltage being greater than the bias voltage and less than or equal to the bus voltage.

5. The IC of claim 1, wherein responsive to removing the bias voltage from the at least some conductors of the electrical connector, the liquid includes a pull-up resistance for the at least some conductors to the bus voltage.

6. The IC of claim 1, wherein the IC is configured to detect the presence of liquid in an electrical connector via one of electrical impedance spectroscopy, leakage measurement, or pulsed measurement.

7. A method, comprising:
introducing an electrical current into an electrical connector;
measuring a voltage in the electrical connector provided responsive to the electrical current;
determining, based on a value of the voltage, a presence of a foreign material in the electrical connector; and
responsive to the presence of the foreign material in the electrical connector, removing a bias voltage from at least some conductors of the electrical connector.

8. The method of claim 7, further comprising:
monitoring a bus voltage of the electrical connector; and
based on a value of the bus voltage determined via the monitoring, performing a corrosion mitigation action responsive to the presence of the foreign material in the electrical connector.

9. The method of claim 8, further comprising, responsive to determining via the monitoring that the bus voltage is greater than a threshold value after a programmed amount of time, providing a notification to a user.

10. The method of claim 8, further comprising, responsive to determining via the monitoring that the bus voltage is less than a threshold value, applying a pull-down resistance to the at least some conductors.

11. The method of claim 8, wherein responsive to removing the bias voltage from the at least some conductors of the electrical connector, the at least some conductors have a voltage potential difference less than a difference threshold with respect to the bus voltage.

12. The method of claim 8, further comprising, responsive to the presence of the foreign material in the electrical connector, applying a second bias voltage to the at least some conductors of the electrical connector, the second bias voltage being greater than the bias voltage and less than or equal to the bus voltage.

13. An apparatus, comprising:
a Universal Serial Bus (USB) receptacle; and
a USB controller coupled to the USB receptacle, the USB controller configured to:
detect a presence of liquid in the USB receptacle; and
responsive to the presence of liquid in the USB receptacle, remove a bias voltage from at least some conductors of the USB receptacle.

14. The apparatus of claim 13, wherein the USB controller is configured to:
monitor a bus voltage of the USB receptacle; and
based on a value of the bus voltage determined via the monitoring, perform a corrosion mitigation action responsive to the presence of liquid in the USB receptacle.

15. The apparatus of claim 14, wherein responsive to determining via the monitoring that the bus voltage is greater than a threshold value, the USB controller is configured to provide a notification to a user.

16. The apparatus of claim 15, wherein the USB controller is configured to provide the notification to the user responsive to the bus voltage remaining greater than the threshold value for greater than a programmed amount of time.

17. The apparatus of claim 14, wherein responsive to determining via the monitoring that the bus voltage is less than a threshold value, the USB controller is configured to apply a pull-down resistance to the at least some conductors.

18. The apparatus of claim 14, wherein responsive to the presence of the liquid in the USB receptacle, the USB controller is configured to apply a second bias voltage to the at least some conductors, the second bias voltage being greater than the bias voltage and less than or equal to the bus voltage.

19. The apparatus of claim 13, wherein the USB controller is configured to perform at least one of electrical impedance spectroscopy, leakage measurement, or pulsed measurement to detect the presence of liquid in the USB receptacle.

20. The apparatus of claim 14, wherein the at least some conductors include a USB type C configuration channel pin.
